(19) United States
(12) Patent Application Publication
(10) Pub. No.: US 2013/0252729 A1
(43) Pub. Date: Sep. 26, 2013

(54) VIDEO GAME SYSTEMS AND METHODS FOR PROMOTING MUSICAL ARTISTS AND MUSIC

(71) Applicants: ROBERT V. WELLS, Huntsville, AL (US); Brian K. Mitchell, Huntsville, AL (US)

(72) Inventors: ROBERT V. WELLS, Huntsville, AL (US); Brian K. Mitchell, Huntsville, AL (US)

(21) Appl. No.: 13/786,061

(22) Filed: Mar. 5, 2013

Related U.S. Application Data
(60) Provisional application No. 61/607,192, filed on Mar. 6, 2012.

(51) Int. Cl. A63F 13/00

(52) U.S. Cl. CPC A63F 13/00
USPC 463/31

(57) ABSTRACT

A video game system is configured to play a music-based video game in which an artist's music is incorporated into game play. After the artist's music song is played in the game, the system presents information to the gamer for promoting the artist's music and/or brand, and the system provides the gamer with opportunities to participate in various promotional efforts associated with the artist. As an example, the gamer may be presented with an opportunity to purchase the song or songs played in the game (or other songs by the same artist), request that the artist's song or songs be played on the radio or that the artist play in concert at a nearby venue, to “like” the artist or song in a social media environment, search for additional songs by the same artist, or to go to the artist's website or social media page.

### CROSS REFERENCE TO RELATED APPLICATION

This application claims priority to U.S. Provisional Patent Application No. 61/607,192, entitled “Video Game System for Promoting and Selling Music” and filed on Mar. 6, 2012, which is incorporated herein by reference.

### RELATED ART

The market for musical artists is extremely competitive, and artists are continually searching for new and better ways to promote their music and brands. Popular artists generally have little trouble finding venues to promote their music, such as playing in concerts, having their music played on the radio or in some cases in a video game, or hosting websites or social media followed or viewed by a large number of fans. For less popular or “undiscovered” artists, it can be a daunting and difficult task to effectively market their music and brands to a large number of fans.

Presently, there are various music-based video games that incorporate artists' music into game play, and such games tend to have some branding value for the music and the artists. Furthermore, many music-based games provide the option for the gamer to download additional game levels and associated songs for play within the game. While this tends to further promote the brand of the songs and the artists, the purpose of these games is generally to sell additional game levels to the gamer for the principal benefit of the game. This is typically done with popular artists by paying them, and/or their record label and publisher, to license the use of their songs in the game to capitalize on the artist's brand and popularity to help sell the game itself or to help sell additional game levels in the game based on additional songs from the artist. However, there are many musical artists who do not have a contract with a record label nor do they have a high profile brand or highly popular songs that game companies want to use in their games. As a result, these artists are not usually afforded the opportunity to use video games to promote and directly sell their music to gamers.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a system for promoting musical artists and music.

FIG. 2 is a block diagram illustrating an exemplary embodiment of a game server, such as is depicted by FIG. 1.

FIG. 3 is a block diagram illustrating an exemplary embodiment of a video game apparatus, such as is depicted by FIG. 1.

FIG. 4 is a block diagram illustrating an exemplary image in a music-based video game played by video game logic, such as is depicted by FIG. 1.

FIG. 5 depicts an exemplary graphical user interface displayed by video game logic, such as is depicted by FIG. 1, for providing a gamer with various options for initiating actions related to music played in a video game.

### DETAILED DESCRIPTION

The present disclosure generally pertains to video game systems and methods for promoting musical artists and music. In one exemplary embodiment, a video game system is configured to play a music-based video game in which an artist's music is incorporated into game play. After the artist's music (e.g., song) is played in the game, the system presents information to the gamer for promoting the artist's music and/or brand, and the system provides the gamer with opportunities to participate in various promotional efforts associated with the artist. As an example, the gamer may be presented with an opportunity to purchase the song or songs played in the game (or other songs by the same artist), request that the artist's song or songs be played on the radio or that the artist play in concert at a nearby venue, to “like” the artist or song in a social media environment, search for additional songs by the same artist, or go to the artist's website or social media page. In one embodiment, the video game system incorporates the music and branding of many different artists and can be an effective marketing platform, particularly for lesser known or “undiscovered” artists who typically lack the market power to negotiate with record labels or effectively license their brands.

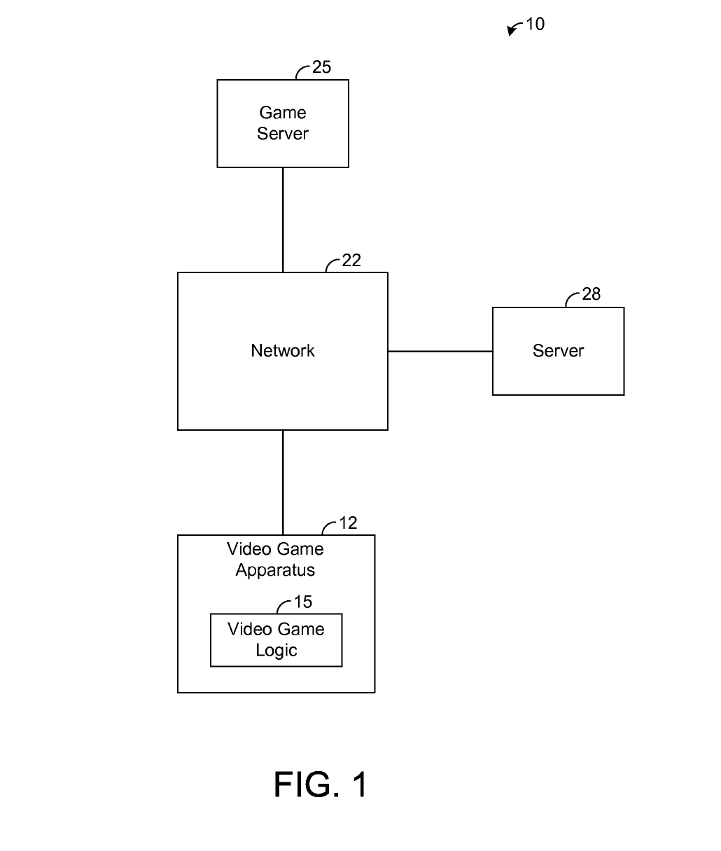

FIG. 1 depicts an exemplary embodiment of a system 10 for promoting musical artists and music. The system 10 comprises a video game apparatus 12 having video game logic 15 for playing a music-based video game that is used to promote artists and music, as will be described in more detail hereafter. The apparatus 15 may comprise a video game console or other type of apparatus (e.g., a desktop computer) that is coupled to a television, monitor, or other display device for providing images and sounds associated with a video game. In one exemplary embodiment, the apparatus 15 is implemented via a mobile communication device, such as a cellular telephone, laptop computer, or personal digital assistant (PDA). Various other types of devices can be used to implement the video game apparatus 15 in other embodiments.

The apparatus 15 is communicatively coupled to a network 22, which is also communicatively coupled to a game server 25 that is configured to interact with the video game logic 15, as will be described in more detail below. In one exemplary embodiment, the network 22 is a wide area network (WAN), such as the Internet, but the network 22 may comprise other types of networks in other embodiments. Further, the network 22 may comprise multiple network types. As an example, the apparatus 12 may be implemented as a cellular device that is configured to communicate with a cellular network that interfaces messages with the Internet. Thus, the apparatus 12 may communicate with the game server 25 via a cellular connection over the Internet. Additionally, the network 22 may comprise a local area network (LAN), such as a home network.

Note that the network 22 may be communicatively coupled to any number of devices or servers. In the embodiment depicted by FIG. 1, the network 22 is communicatively coupled to a server 28, which hosts one or more websites accessible by the video game logic 15 via the network 22, as will be described in more detail hereafter.

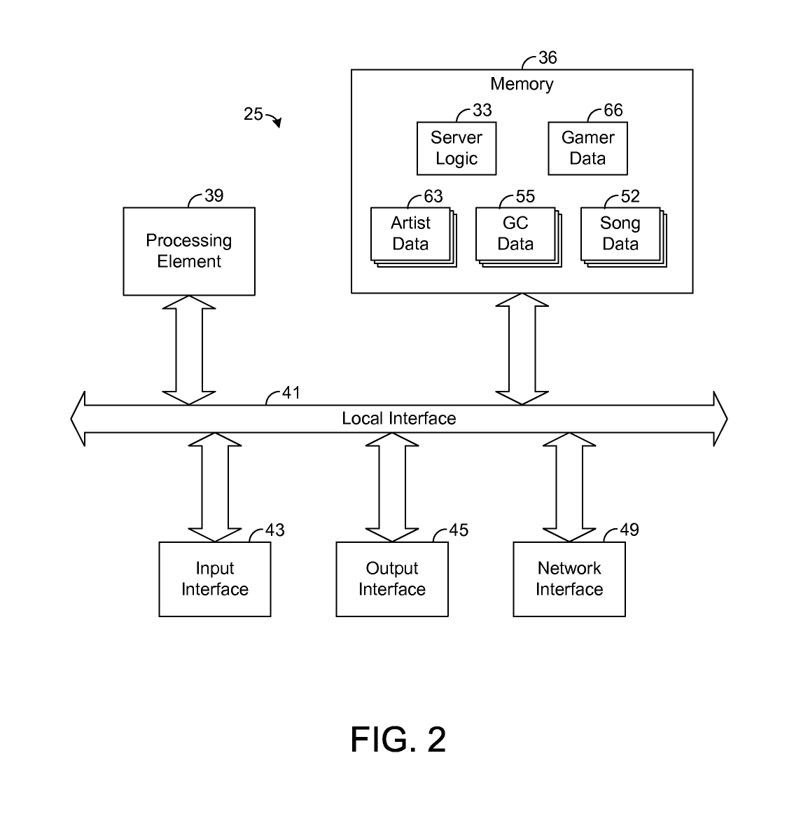

FIG. 2 depicts an exemplary embodiment of the game server 25. As shown by FIG. 2, the server 25 comprises server logic 33 for generally controlling the operation of the server 25, as will be described in more detail hereafter. The server logic 33 can be implemented in software, hardware, firmware or any combination thereof. In the exemplary server 25 illustrated by FIG. 2, the server logic 33 is implemented in software and stored in memory 36 of the server 25.

Note that the server logic 33, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary server 25 depicted by FIG. 2 comprises at least one conventional processing element 39, such as a digital signal processor (DSP) or a central processing unit (CPU), that communicates to and drives the other elements within the server 25 via a local interface 41, which can include at least one bus. Furthermore, an input interface 43, for example, a keyboard or mouse, can be used to input data from a user of the server 25, and an output interface 45, for example, a printer, monitor, liquid crystal display (LCD), or other display device, can be used to output data to the user. Further, a network interface 49, such as at least one modem, may be used to exchange data with the network 22 (FIG. 1).

As shown by FIG. 2, the server 25 stores sets of song data 52 that can be downloaded to the video game apparatus 12 (FIG. 1) for use by the video game logic 15. In one exemplary embodiment, each set of song data 52 is an MP3 file defining a musical song performed by a particular artist. The name of the artist and the name of the song are defined by metadata within the file so that the sets of song data 52 can be searched to find a song or songs of interest. In other embodiments, other formats and techniques for storing the song data 52 are possible. As an example, a set of song data 52 may define multiple songs by the same artists or a group of artists.

Each set of song data 52 is correlated with a set of game content (GC) data 55 that is also stored in the memory 36 of the server 25. The correlated set of game content data 55 defines various attributes of game play that are used by the video game logic 15 to control images or actions that occur in a video game, as will be described in more detail below.

Sets of artist data 63 are also stored in memory 36. Each set of artist data 63 indicates various information, including images, that are to be used in the video game played by the video game logic 15 (FIG. 1) for promoting the artist in the video game. As an example, the artist data 63 for a particular artist may define the artist's logos, slogans, messages, and images unique to the artist that may be displayed to the user of the video game apparatus 12.

The server logic 33 is configured to communicate with the video game logic 15 (FIG. 1) to define and maintain gamer data 66 that is also stored in memory 36. The gamer data 66 indicates various metrics about the gamer's behavior in playing the video game. As an example, the gamer data 66 may indicate which sets of song data 52 (e.g., songs) have been selected by the gamer for play in the video game, and the number of times that the gamer has so selected the sets of song data 52.

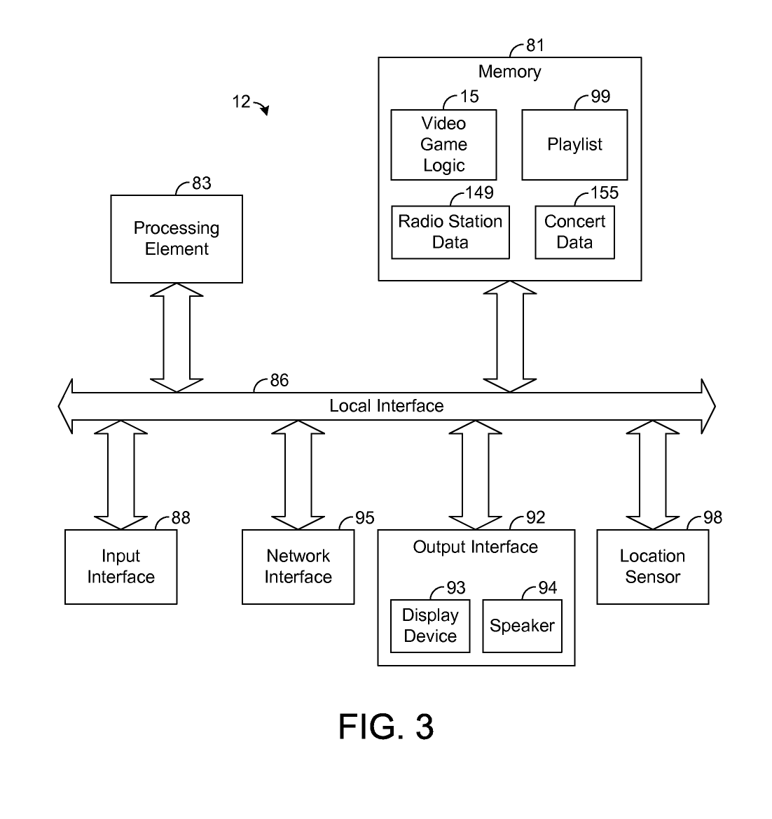

FIG. 3 depicts an exemplary embodiment of the video game apparatus 12. As shown by FIG. 3, the apparatus 12 comprises video game logic 15 for generally controlling and playing a video game, as will be described in more detail hereafter. The video game logic 15 can be implemented in software, hardware, firmware or any combination thereof. In the exemplary apparatus 12 illustrated by FIG. 3, the video game logic 15 is implemented in software and stored in memory 81 of the apparatus 12. Note that the video game logic 15, when implemented in software, can be stored and transported on any computer-readable medium for use by or in connection with an instruction execution apparatus that can fetch and execute instructions.

The exemplary apparatus 12 depicted by FIG. 3 comprises at least one conventional processing element 83, such as a digital signal processor (DSP) or a central processing unit (CPU), that communicates to and drives the other elements within the apparatus 12 via a local interface 86, which can include at least one bus. Furthermore, an input interface 88, for example, a keyboard or mouse, can be used to input data from a user (referred to herein as “gamer”) of the apparatus 12, and an output interface 92 can be used to output data to the gamer. As shown by FIG. 3, the output interface comprises a display device 93, for example, a printer, monitor, television, liquid crystal display (LCD), or other display device, for rendering graphical images to a user and a speaker for emitting sound, such as songs. Note that the same apparatus, such as touchscreen that is capable of both displaying data and receiving inputs, may implement both the input interface 88 and the display device 93. Further, a network interface 95, such as at least one modem, may be used to exchange data with the network 22 (FIG. 1).

The apparatus 12 also comprises a location sensor 98, such as a global positioning system (GPS) sensor, for determining a location of the apparatus 12. As an example, when a GPS sensor is used, the location sensor 98 receives satellite signals for which triangulation or other similar location determining algorithms can be used to determine the geographic coordinates of the apparatus 12. In other embodiments, other types of location sensors may be used.

Note that the video game logic 15 can be configured to implement any type of music-based video game. For illustrative purposes, an exemplary operation and use of the video game logic 15 will be described in more detail below, but it should be emphasized that the promotional features for artists and music described herein can be used with video games of various types.

Once the video game logic 15 is downloaded or otherwise installed on the apparatus 12, the video game logic 15 is configured to contact the game server 25 in order to access information stored at the server 25, as will be described in more detail below. In this regard, the video game logic 15 is configured to prompt the gamer to select his or her favorite artist from a list of artists defined by the artist data 63. Upon selection of the gamer's favorite artist, data indicative of the selected artist is transmitted from the video game logic 15 to the server logic 33, which stores such data in the gamer data 66. In addition, the video game logic 15 is configured to access the set of artist data 63 correlated with the selected artist and to use such data in game play. For example, the video game logic 15 is configured to render a graphical user interface (GUI) in which images of the video game are displayed, and attributes of the GUI affecting the look and feel of the video game may be selected or changed based on the selected artist. For instance, images, logos, slogans, messages, or other content defined by the correlated set of artist data 63 may be used to populate the game environment, such as background or borders of the GUI. Other attributes of the video game may be affected by the gamer's selection of his or her favorite artist, as will be described in more detail below.

After communication between the game server 25 and video game logic 15 has been established and the gamer has selected his or her favorite artist, the server logic 33 is configured to download a playlist 99 (FIG. 3) to the video game apparatus 12. The playlist 99 defines a list of music (e.g., songs) to be played in the video game. In one exemplary embodiment, the playlist 99 is populated with song names from the song data 52. That is, each item in the playlist 99 is correlated with and identifies a respective one of the sets of song data 52. The songs are listed in order of play such that the first song in the playlist 99 is to be played first and the last song in the playlist 99 is to be played last.

In one exemplary embodiment, the playlist 99, including the music selected for play in the playlist and the order of the music in the playlist, is affected by the gamer's selection of his or her favorite artist. As an example, based on the gamer's selection of his or her favorite artist, the server logic 33 is configured to select at least one song associated with such artist for inclusion in the playlist 99 (possibly among music by other artists) without the user specifically selecting such song or songs, and the server logic 33 is configured to place one or more songs associated with the artist higher in the playlist order so that a song or songs of the selected artist are played sooner. That is, the server logic 33 automatically determines a default order of songs that is presented to the gamer before the gamer has the opportunity to select specific songs for inclusion in the playlist 99. Not only does the server logic 33 select songs of the gamer's favorite artist for inclusion in the default playlist 99, but such artist's songs are given preferential weighting so that they appear higher in the playlist order due to the gamer's selection of the artist as his or her favorite.

Note that other factors may be used to control the playlist music. As an example, the video game logic 15 may prompt the gamer to define various music attributes, such as genre, that are appealing to the gamer, and the server logic 33 may control song selection and ordering accordingly. Once the playlist 99 has been downloaded, the video game logic 15 is configured to display the playlist 99 to the gamer and to permit the gamer to make changes to the playlist 99 such as removing songs from the playlist 99, adding songs to the playlist 99, or rearranging the order of songs in the playlist 99.

Once gameplay commences, the video game logic 15 is configured to play the songs in the playlist 99 according to the playlist order. In this regard, the video game logic 15 communicates with the game server 25 in order to download the sets of song data 52 for the songs in the playlist 99, and the video game logic 15 plays such song data 52 to the gamer during gameplay so that the gamer hears the songs defined by such song data 52.

In addition, for each such set of song data 52, the video game logic 15 also communicates with the game server 25 to download the correlated set of game content data 55, which is used in gameplay when the correlated set of song data 52 is being played. Note that there are various ways that the game content data 55 can be used in the game.

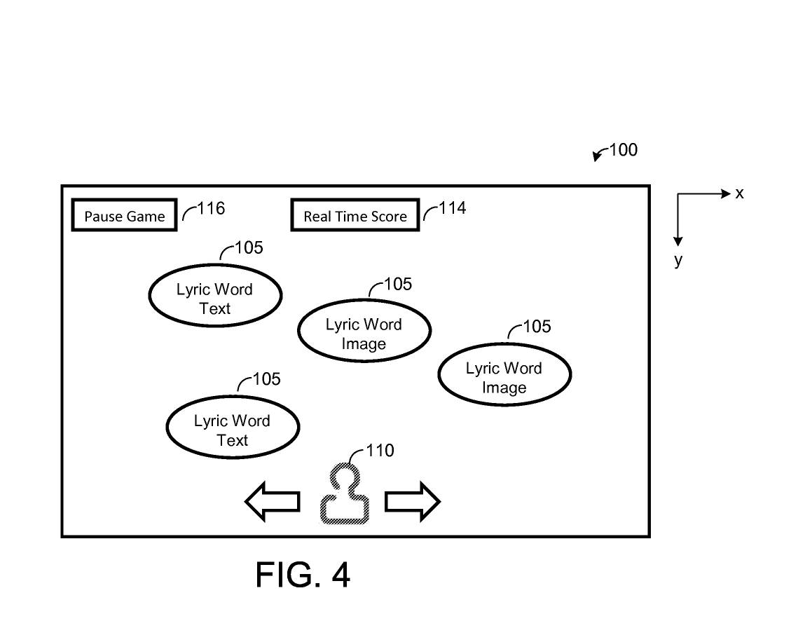

As an example, FIG. 4 depicts an exemplary image 100 that is displayed by the video game logic 15 during gameplay. As shown by FIG. 4, the image 100 has graphical objects 105 that fall vertically (in the y-direction) toward a graphical character 110 that is controllable by the gamer via user input. In this regard, the character 110 can be moved horizontally (parallel to the x-direction) in response to user input. Each object 105 is initially displayed toward the top of the image 100 and falls toward the bottom of the image 100. When a vertical position close to that of the character 110 is reached, the object 105 disappears from the image 100, and new objects 105 are newly created during gameplay.

Each object 105 represents either a lyric word text or lyric word image associated with the song being played. As an example, when a particular phrase is heard in a song being played in the video game, the text of such phrase may appear in an object that appears at about the same time the phrase is heard. Alternatively, an object 105 may define a musical note or an icon that is uniquely associated with the song being played. As an example, if the lyrics of a song reference a beer bottle, an object 105 may define an image of a beer bottle.

Note that the data defining the content (e.g., text or graphics) of the objects 105 is from the game content data 55 that is correlated with the set of song data 52 being played. In other embodiments, the game content data 55 may control other attributes of the gameplay.

In the exemplary game being described, the gamer moves the character 110 horizontally as the objects 105 fall in an attempt to have the character 110 aligned horizontally with each object 105 as the object reaches the approximate vertical position of the character 110 such that it appears as if the character 110 is catching the objects 105. The video game logic 15 keeps a running score indicative of the number of objects 105 successfully caught by the character 110. As an example, the video game logic 15 may increase the gamer's score by a certain amount each time an object 105 is successfully caught. As shown by FIG. 4, such score is displayed as a graphical object 114 of the video game. The logic 15 also displays a graphical object 116 for which the logic 15 pauses gameplay in response to selection of the object 116.

In one exemplary embodiment, the video game logic 12 informs the server logic 33 each time a set of song data 52 is played in the video game, and the server logic 33 updates the gamer data 66 to indicate which sets of song data 52 have been played, as well as the number (referred to herein as “play count”) of times that each set of song data 52 is played. In addition, each time the server logic 33 updates the play count for a given set of song data 52, the server logic 33 compares the updated play count to a threshold. If the play count exceeds the threshold, then the server logic 33 takes a predefined action.

As an example, in one embodiment, the gamer is permitted to play a given set of song data 52 in the video game a certain number (e.g., three) of times free of charge. After such number is reached, the server logic 33 prevents the set of song data 52 from being included in the playlist 99 and, hence, being played in the video game until the gamer pays a fee, thereby purchasing the right to continue playing the set of song data 52 in the video game. There are various techniques that can be used to prevent a set of song data 52 from being played in the video game after the threshold is reached. As an example, in one exemplary embodiment, the server logic 33 associates each set of song data 52 with a state variable indicating the number of times that the set of song data 52 has been played. Once threshold is reached, the server logic 33 changes the state variable to indicate that it is disabled from further play. After verification that the gamer has paid a fee for continued use of the disabled set of song data 52, the server logic 33 again updates the state variable to indicate that the associated set of song data 52 may be played an unlimited number (or other number) of times in the video game.

In one exemplary embodiment, the server logic 33 informs the video game logic 15 which sets of song data 52 are currently disabled from further play in the video game, and the video game logic 15 maintains a list of such sets of song data 15. Once a given set of song data 52 is played in the video game a certain number of times, an identifier (e.g., song name) of such set of song data 52 is automatically included in the list. In addition, the video game logic 52 checks such list before allowing the gamer to add a song to the playlist 99. If the song to be added is included in the list of disabled songs, then the video game logic 52 does not allow the song to be added to the playlist 99 thereby preventing the song from being played in the video game. Once the gamer pays for the right to continue playing the set of song data 52, the server logic 33 informs the video game logic 15, which removes such identifier from the list of disabled songs. In other embodiments, other techniques for controlling which sets of song data 52 are permitted for inclusion in the playlist 99 are possible.

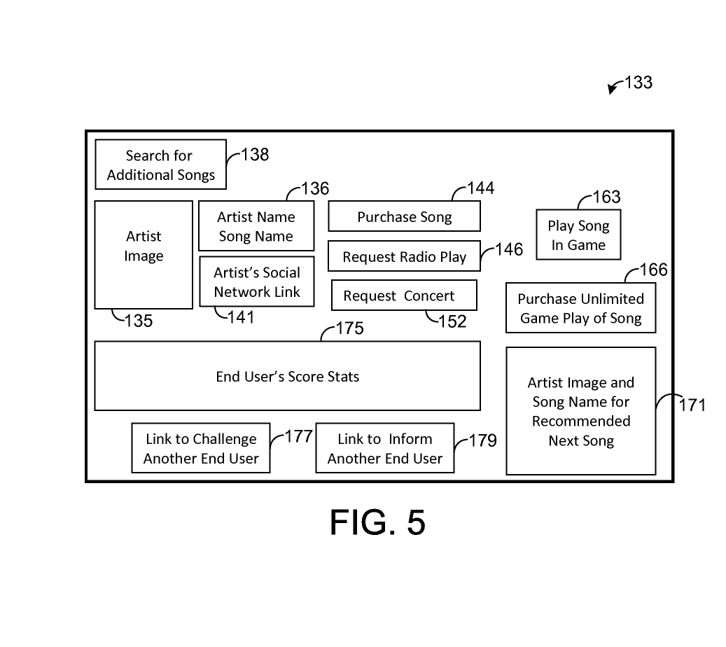

After a set of song data 52 is played in the game, the video game logic 15 displays to the gamer a GUI that promotes the artist and music and that provides the gamer with various options for initiating actions related to the music. FIG. 5 depicts an exemplary GUI 133 that is displayed to the gamer after a song is played from the playlist 99 and the gamer has attempted to catch objects 105 (FIG. 4) correlated with the song. As shown by FIG. 5, the GUI 133 displays an image 135 of the artist who performed the song and text 136 indicating the artist's name and the song name, thereby helping to brand the artist and his or her music. The GUI 133 also has a graphical object 138 that can be selected by the gamer for initiating a search of additional songs to add to the playlist 99. In response to selection of this object 138, the video game logic 15 renders another object displaying the list of songs that can be added to the playlist 99.

As shown by FIG. 5, the GUI 133 also has a graphical object 141 that can be selected by the gamer for initiating access to a social network page or other web page of the artist. As an example, in response to selection of the object 141 by the gamer, the video game logic 15 notifies the server logic 33, which directs the apparatus 12 to the artist's Facebook page or page of some other type of social network.

The GUI 133 also has a graphical object 144 that can be selected by the gamer for initiating a purchase of the song most recently played in the video game. In response to selection of the object 144 by the gamer, the video game logic 15 directs the apparatus 12 to a website where the song can be purchased by the gamer. As an example, the server 28 (FIG. 1) may host a website where songs can be purchased for downloading. The video game logic 15 preferably stores the address (e.g., URL) of such website and uses the stored address to establish a session with the server 28 for purchasing the song. In one embodiment, the video game logic 15 submits a request through a web browser (not shown) of the apparatus 12 requesting from the server 28 a webpage that can be used to purchase the song. The request preferably includes the address (e.g., URL) of the website as well as the artist name and song name so that the server 28 can automatically present the song for purchase without requiring the gamer to search the website for the song of interest. That is, upon selection of the object 144, the song that was just played in the video game is offered to the gamer for purchase without the gamer having to provide any further inputs for identifying the song or artist. Note that the purchase of the song in this instance is unrelated to gameplay. That is, the gamer is purchasing the song for play outside of the video game. Thus, if purchased, the song can be played on the apparatus 12 without running the video game logic 15, and the song can be played on other devices of the gamer depending on the terms of the purchase. In other embodiments, other techniques are possible for initiating a purchase of the song.

The GUI 133 also has a graphical object 146 that can be selected by the gamer for initiating a request for at least one local radio station to play on a radio channel the song most recently played in the video game. In this regard, in one exemplary embodiment, the video game logic 15 stores radio station data 149 (FIG. 3) that indicates the contact information for submitting such requests for different geographic regions. The video game logic 15 determines, based on the location sensor 98, the location of the apparatus 12 at the time of selection of the object 146, and based on such location selects at least one nearby radio station indicated by the data 149.

As an example, each entry of the data 149 may pertain to a respective radio station and include contact information for submitting a request for that radio station to play a song. Such entry may include the location coordinates of the radio station, and the video game logic 15 is configured to compare such coordinates to those of the location sensor 98. If the difference between such coordinates is within a specified range, then the video game logic 15 is configured to submit a request for that radio station to play a song using the contact information that is stored in the same entry. The contact information could be an email address or website address for the radio station. As an example, the radio station could maintain a website where users can submit requests for the radio station to play songs. The video game logic 15, in response to selection of the object 146, is configured to automatically submit a request through the website for the song just played in the video game.

Note that there are currently third party websites that aggregate requests for radio station song play from consumers. In this regard, a user may contact such a website and submit a request for a radio station to play a song. The server hosting such website aggregates requests for the same song, and submits to a radio station a request for the song indicating the total number of consumers who have requested the song through the website. The contact information used by the video game logic 15 described above may specify such a website so that the video game logic 15 submits a request through such website.

In one exemplary embodiment, the coordinates determined by the location sensor 98 are translated into an identifier of a geographic region for comparison with the radio station data 149. As an example, each radio station within the data 149 may be identified by the city or zip code serviced by the radio station. In such case, the video game logic 15 is configured to translate the location coordinates from the sensor 98 into a city name or zip code number for comparison with the data 149 in order to locate the radio station entries pertaining to such city name or zip code number.

In addition, it is possible for the radio station data 149 to be stored at the game server 25 and for the server logic 33 rather than the video game logic 15 to be responsible for submitting requests for song play by radio stations. In such case, the video game logic 15 notifies the server logic 33 when the object 146 is selected by the gamer, and the server logic 33 then submits a request for a radio station to play the song. In addition, the server logic 33 may be configured to aggregate requests by multiple gamers from multiple video game apparatuses 12 before sending a request for a given song. As an example, the server logic 33 may count the number of gamers that requested the same song over a certain time interval and then submit a request that identifies the song name, the artist for the song, and the total number of gamers who have requested the song during a certain time period. Various other techniques for initiating a request for a song to be played by a radio station are possible in other embodiments.

The GUI 133 also has an object 152 that is selectable by the gamer for requesting that the artist play a concert at a local venue relative to the location of the apparatus 12, similar to the requests for song play by radio stations described above. In this regard, the video game logic 15 stores in the apparatus 12 concert data 155 (FIG. 3) that indicates the contact information for submitting such requests for different geographic regions, similar to the radio station data 149 described above. The video game logic 15 determines, based on the location sensor 98, the location of the apparatus 12 at the time of selection of the object 152, and based on such location selects at least one nearby venue indicated by the concert data 155.

As an example, there are currently third party websites that aggregate requests for concert play from consumers. In this regard, a user may contact such a website and submit a request for an artist to play a concert at a particular venue. The server hosting such website aggregates requests for the same artist and venue, and submits to the artist, a record label affiliated with the artist, or other entity affiliated with the artist a request for the artist to play a concert at the venue indicating the total number of consumers who have requested the concert through the website.

Each entry of the data 155 may pertain to a respective venue and include contact information (e.g., email or website address) for submitting a request for a concert at that venue. Such entry may include the location coordinates of the venue, and the video game logic 15 is configured to compare such coordinates to those of the location sensor 98. If the difference between such coordinates is within a specified range, then the video game logic 15 is configured to submit a request for a concert at such venue by the artist for the song just played in the video game. As described above for the request for radio station play, the video game logic 15 may convert the location coordinates into a zip code, city name, or other geographic identifier, and automatically identify the contact information for a local venue based on such information. In other embodiments, other techniques for requesting a concert by such artist are possible. In addition, it is possible for the concert data 155 to be stored at the game server 25 and for the server logic 33 to be responsible for submitting requests for concerts, similar to the requests for radio station play described above.

As an example, the video game logic 15 notifies the server logic 33 when the object 152 is selected by the gamer, and the server logic 33 then submits a request for a concert, as described above for the video game logic 15. In addition, the server logic 33 may be configured to aggregate by venue requests from multiple gamers using multiple apparatuses 12 for a concert of the same artist. That is, the server logic 33 may store and maintain data indicating the total number of requests for the same artist at a certain venue. The server logic 33 may then send a message to the operator of the venue, the artist, a record label affiliated with the artist, or other entity requesting that the artist perform a concert at the venue and indicating the total number of requests that have been received from gamers. Alternatively, the server logic 33 may submit a request for a concert through a third party website that manages such requests, as described above.

The GUI 133 also has a graphical object 163 that is selectable by the gamer for initiating another play of the same song in the video game. In response to selection of this object 163, the video game logic 15 begins playing the song in the video game.

As further shown by FIG. 5, the GUI 133 has a graphical object 166 that is selectable by the gamer for initiating a purchase of an unlimited number of plays of the song in the video game. In this regard, as described above, each song may have a limit on the number of times it can be played in the video game free of charge. In response to selection of the object 166, the video game logic 15 initiates a process by which the gamer can remove such limit for a fee. As an example, the video game logic 15 may inform the server logic 33 of the selection of object 166, and the server logic 33 may then communicate with the gamer via the network 22 and apparatus 12 or otherwise to solicit the payment of a fee for removing the song limit. Once payment of the fee is confirmed, the server logic 33 notifies the video game logic 15, which then permits additional (e.g., unlimited) plays of the song in the video game.

The GUI 133 also has a graphical object 171 defining an image of an artist and the name of a song that is recommended for play as the next song in game play. Such song may be the next set of song data 152 in the playlist 99, or the song may be selected by the video game logic 15 based on various factors, such as the number of times it has been played in the video game or its relation (e.g., same genre) as the song just played.

As shown by FIG. 5, the GUI 133 also has a graphical object 175 defining an image that indicates the gamer's score in playing the video game. In one embodiment, the score is based on the gamer's performance in playing the video game during the last song that was just played, and the gamer can submit a challenge to a friend for the same song. In this regard, the GUI 133 has a graphical object 177 that can be selected by the gamer for initiating a challenge to a friend. In response to selection of the object 177, the video game logic 15 defines a message (referred to herein as a “challenge”) that includes the gamer's score indicated by image 175 and an identifier (e.g., artist name and song name) of the song, and the logic 15 sends the challenge to a gamer's friend via the network 22 or otherwise.

In this regard, data indicative of contact information (e.g., email address or address for a text message) is stored by the video game logic 15, and this information is used to automatically send a challenge by email, text message (e.g., Short Message Service (SMS) or other types of protocols), or otherwise upon selection of the object 177. In one embodiment, selection of the object 177 causes the video game logic 15 to display another GUI (not shown) for defining the challenge. Such GUI may permit the gamer to select the friend to receive the challenge or to define the contact information for the friend. In addition, such GUI may permit the gamer to personalize the challenge. In one exemplary embodiment, the challenge comprises predefined text that is automatically inserted into the challenge by the video game logic 15. Such predefined text includes the name of the song, the gamer's score associated with the song in gameplay (i.e., the score earned by the gamer while the song is playing in the video game), and text that challenges the friend to try to beat the gamer's score. If desired, the gamer may add a personalized message.

Note that the challenge may include a graphical object (not shown) that the friend can select for accepting the challenge. If selected, video game logic 15 of the friend's apparatus 12 is configured to add the song to his or her playlist 99. Similarly, if the gamer of the apparatus 12 depicted by FIG. 3 receives a similar challenge, the gamer may accept the challenge by selecting a particular object in the challenge or otherwise. In response to acceptance of the challenge, the video game logic 15 is configured to add the identified song to the gamer's playlist 99 so that the song is played in the video game.

In addition, the GUI 133 has a graphical object 179 that can be selected by the gamer for initiating a message to a friend similar to the challenge described above. The video game logic 15 automatically inserts into such message the gamer's score and an identifier (e.g., song name and artist name) of the song just played. The message may be communicated to a friend via the same techniques described above for the challenge. As an example, after accepting a challenge from friend for a particular song, the gamer may use the graphical object 179 to send a message to that friend after playing the song at issue in the video game.

It should be noted that several of the actions initiated by the user through the GUI 133 are performed externally to the video game. As an example, when the gamer purchases a song via selection of the object 144, a transaction for purchasing the song is initiated by the video game logic 15, but the transaction itself is performed independently of the video game, including both the video game logic 15 and the gamer server 25. In this regard, once the gamer is directed to the website of the server 28 for purchasing the song, the remainder of the transaction can occur using a web browser (not shown) of the apparatus 12 without using the video game logic 15 or the game server 25. Further, when the song is purchased, it is purchased for play outside of the video game. As an example, it can be played via the apparatus 12 or another device without the use of the video game logic 15 or the game server 25. In addition, websites or other destinations for receiving requests or messages initiated via selection of the objects 146, 152, 177, and 179 are external to the video game and operate independently of the video game logic 15 and game server 25.

1. A system for promoting musical artists and music, comprising:
a display device;
a speaker;
memory for storing sets of song data and sets of game content data, each of the sets of game content data correlated with a respective set of the song data; and
logic configured to play a music-based video game via the display device and speaker, the logic configured to cause the speaker to play in the video game a song defined by one of the sets of the song data, the logic further configured to control, based on one of the sets of the game content data correlated with the one set of the song data, at least one attribute of a graphical object within an image of the video game displayed via the display device while the speaker is playing the song in the video game, wherein the logic is configured to display, after play of the song in the video game, at least one option for initiating an action related to the song or an artist associated with the song external to the video game.

2. The system of claim 1, wherein the logic is configured to display an option for initiating a purchase of the song for use external to the video game.

3. The system of claim 1, wherein the logic is configured to display an option for initiating access of a website or a social network page of an artist associated with the song.

4. The system of claim 1, wherein the logic is configured to display an option for initiating a message, wherein the logic is configured to automatically insert a name of the song into the message in response to selection of the option for initiating the message, and wherein the logic is configured to transmit the message via a network.

5. The system of claim 4, wherein the logic is configured to automatically insert a score from the video game into the message in response to the selection of the option for initiating the message.

6. The system of claim 1, wherein the logic is configured to disable the one set of the song data from further play in the video game once the one set of the song data has been played a threshold number of times in the video game.

7. The system of claim 6, wherein the logic is configured permit further play of the one set of the song data in the video game in response to a payment of a fee for continued play of the one set of the song data.

8. The system of claim 1, wherein the logic is configured to receive a user input from a user for selecting an artist associated with at least one of the sets of the song data, wherein the logic is configured to define a default playlist indicative of the sets of the song data to be played in the video game, and wherein the logic is configured to select for inclusion in the playlist at least one of the sets of the song data associated with the selected artist based on the user input without the user selecting for inclusion in the default playlist the set of the song data associated with the selected artist.

9. The system of claim 8, wherein the logic is configured to display in the video game at least one image of the selected artist based on the user input.

10. The system of claim 1, wherein the logic is configured to display an option for initiating a request for the song to be played by a radio station.

11. The system of claim 10, further comprising a location sensor, wherein the request is based on location data from the location sensor.

12. The system of claim 1, wherein the logic is configured to display an option for initiating a request for an artist associated with the song to play a concert.

13. The system of claim 12, further comprising a location sensor, wherein the request is based on location data from the location sensor.

14. A method for promoting musical artists and music, comprising:
storing, in memory, sets of song data and sets of game content data;
correlating each of the sets of game content data with a respective set of the song data;
playing a music-based video game via a display device and a speaker, wherein the playing comprises displaying an image via the display device and causing the speaker to play in the video game a song defined by one of the sets of the song data during the displaying;
controlling at least one attribute of graphical object within an image of the video game based on one of the sets of the game content data correlated with the one set of the song data; and
displaying, after the song is played in the video game, at least one option for initiating an action external to the video game, wherein the action is related to the song or an artist associated with the song.

15. The method of claim 14, further comprising:
displaying via the display device an option for initiating a purchase of the song for use external to the video game; and
initiating the purchase in response to a user input for selecting the option.

16. The method of claim 14, further comprising:
displaying via the display device an option for initiating access of a website or a social network page of an artist associated with the song; and
initiating the access of the website or the social network page in response to a user input for selecting the option.

17. The method of claim 14, further comprising:
displaying via the display device an option for initiating a message;
automatically inserting a name of the song into the message in response to a user input for selecting the option; and
transmitting the message via a network.

18. The method of claim 17, further comprising automatically inserting a score from the video game into the message in response to the user input.

19. The method of claim 14, further comprising:
determining when the one set of the song data has been played in the video game at least a threshold number of times; and
disabling the one set of the song data from further play in the video game in response to the determining.

20. The method of claim 19, further comprising permitting further play of the one set of the song data in the video game after the disabling in response to a payment of a fee for continued play of the one set of the song data.

21. The method of claim 14, further comprising:
receiving a user input from a user for selecting an artist associated with at least one of the sets of the song data;
defining a default playlist indicative of the sets of the song data to be played in the video game; and
automatically selecting for inclusion in the playlist at least one of the sets of the song data associated with the selected artist based on the user input without the user selecting for inclusion in the default playlist the set of the song data associated with the selected artist.

22. The method of claim 21, further comprising displaying in the video game at least one image of the selected artist based on the user input.

23. The method of claim 14, further comprising:
displaying an option for initiating a request for the song to be played by a radio station; and
initiating the request in response to a user input for selecting the option.

24. The method of claim 23, wherein the request is based on a location sensor.

25. The method of claim 14, further comprising:
displaying an option for initiating a request for an artist associated with the song to play a concert; and
initiating the request in response to a user input for selecting the option.

26. The method of claim 25, wherein the request is based on a location sensor.
